(19) United States
(12) Patent Application Publication
(10) Pub. No.: US 2025/0246151 A1
(43) Pub. Date: Jul. 31, 2025

(54) GATE DRIVER AND DISPLAY APPARATUS INCLUDING THE SAME

(71) Applicant: Samsung Display Co., LTD., Yongin-si (KR)

(72) Inventors: NACKHYEON KEUM, Yongin-si (KR); GEUMJU MOON, Yongin-si (KR); KWANGSAE LEE, Yongin-si (KR)

(21) Appl. No.: 18/964,161

(22) Filed: Nov. 29, 2024

(30) Foreign Application Priority Data
Jan. 25, 2024 (KR) 10-2024-0011564

(51) Int. Cl. G09G 3/3266

(52) U.S. Cl. CPC G09G 3/3266; G09G 2300/0426; G09G 2300/0852; G09G 2300/0861; G09G 2310/0286; G09G 2310/08; G09G 2320/0276; G09G 2330/021; G09G 2330/028; G09G 2354/00

(57) ABSTRACT

A gate driver includes a pull-up circuit, a pull-down circuit, a first control circuit, a second control circuit and a third control circuit. The pull-up circuit outputs a first clock signal as a gate output signal in response to a voltage of a first control node. The pull-down circuit pulls down the gate output signal to a power voltage in response to a voltage of a second control node. The first control circuit applies the first clock signal to the first control node in response to the voltage of the second control node. The second control circuit controls a voltage of the first control node in response to a voltage of a third control node and a second clock signal. The third control circuit applies a masking enable signal to the third control node in response to the first clock signal.

This application claims priority to Korean Patent Application No. 10-2024-0011564, filed on Jan. 25, 2024, and all the benefits accruing therefrom under 35 U.S.C. § 119, the content of which in its entirety is herein incorporated by reference.

### BACKGROUND

### 1. Field

Embodiments of the inventive concept relate to a gate driver and a display apparatus including the gate driver. More particularly, embodiments of the inventive concept relate to a gate driver reducing a power consumption and a display apparatus including the gate driver.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver, a data driver, an emission driver and a driving controller. The gate driver outputs gate signals to the gate lines, respectively. The data driver outputs data voltages to the data lines. The emission driver outputs emission signals to the emission lines, respectively. The driving controller controls the gate driver, the data driver and the emission driver.

When an image displayed on the display panel is a static image or the display panel is operated in always on mode, a driving frequency of the display panel may be decreased to reduce a power consumption.

### SUMMARY

When a portion of a display panel displays a static image and another portion of the display panel displays a moving image in a conventional low frequency driving method, the display panel may be driven in a high driving frequency based on the moving image. Thus, when a portion of the display panel displays a static image and another portion of the display panel displays a moving image, the power consumption of the display apparatus may not be sufficiently decreased.

Embodiments of the inventive concept provide a gate driver supporting a multiple division of a driving frequency to reduce a power consumption of the display apparatus.

Embodiments of the inventive concept also provide a display apparatus including the gate driver.

In an embodiment of a gate driver according to the inventive concept, the gate driver includes a pull-up circuit, a pull-down circuit, a first control circuit, a second control circuit and a third control circuit. The pull-up circuit outputs a first clock signal as a gate output signal in response to a voltage of a first control node. The pull-down circuit pulls down the gate output signal to a power voltage in response to a voltage of a second control node. The first control circuit applies the first clock signal to the first control node in response to the voltage of the second control node. The second control circuit controls a voltage of the first control node in response to a voltage of a third control node and a second clock signal. The third control circuit applies a masking enable signal to the third control node in response to the first clock signal.

In an embodiment, the pull-up circuit may include a ninth transistor including a control electrode connected to the first control node, a first electrode which receives the first clock signal and a second electrode connected to a gate output terminal.

In an embodiment, the pull-down circuit may include a tenth transistor including a control electrode connected to the second control node, a first electrode connected to a gate output terminal and a second electrode which receives the power voltage.

In an embodiment, the first control circuit may include an eleventh transistor including a control electrode connected to the second control node, a first electrode which receives the first clock signal and a second electrode connected to the first control node.

In an embodiment, the second control circuit may include a sixth transistor including a control electrode connected to the third control node, a first electrode connected to a first node and a second electrode which receives the second clock signal and a seventh transistor including a control electrode which receives the second clock signal, a first electrode connected to the first node and a second electrode connected to the first control node.

In an embodiment, the second control circuit may further include a second capacitor including a first electrode connected to the third control node and a second electrode connected to the first node.

In an embodiment, the third control circuit may include a third transistor including a control electrode which receives the first clock signal, a first electrode which receives the masking enable signal and a second electrode connected to a second node.

In an embodiment, the gate driver may further include a fourth transistor including a control electrode which receives the power voltage, a first electrode connected to the second node and a second electrode connected to the third control node.

In an embodiment, the gate driver may further include a fourth control circuit which controls the voltage of the third control node using the first clock signal in response to the voltage of the second control node.

In an embodiment, the gate driver may further include a short preventing circuit which prevents a short between the first clock signal and the voltage of the third control node.

In an embodiment, the fourth control circuit may include a fifth transistor including a control electrode connected to the second control node, a first electrode which receives the first clock signal and a second electrode connected to a third node. The short preventing circuit may include a twelfth transistor including a control electrode which receive the masking enable signal, a first electrode connected to the third node and a second electrode connected to a second node.

In an embodiment, the gate driver may further include a fifth control circuit which controls the voltage of the second control node using the second clock signal in response to the second control node.

In an embodiment, the fifth control circuit may include a second transistor including a control electrode connected to the second control node, a first electrode connected to a fourth node and a second electrode which receives the second clock signal and a third capacitor including a first electrode connected to the second control node and a second electrode connected to the fourth node.

In an embodiment, the gate driver may further include an input circuit which applies an input signal to the second control node in response to the first clock signal.

In an embodiment, the input circuit may include a first transistor including a control electrode which receives the first clock signal, a first electrode which receives the input signal and a second electrode connected to a fifth node and an eighth transistor including a control electrode which receives the power voltage, a first electrode connected to the fifth node and a second electrode connected to the second control node.

In an embodiment, the gate driver may further include a first capacitor including a first electrode which receives the first clock signal and a second electrode connected to the first control node.

In an embodiment, in a state in which the masking enable signal has an inactive level, a gate output terminal may output the gate output signal. In a state in which the masking enable signal has an active pulse, the gate output terminal may not output the gate output signal.

In an embodiment of a gate driver according to the inventive concept, the gate driver includes a first transistor including a control electrode which receives a first clock signal, a first electrode which receives an input signal and a second electrode connected to a fifth node, a second transistor including a control electrode connected to a second control node, a first electrode connected to a fourth node and a second electrode connected to the second control node, a third transistor including a control electrode which receives the first clock signal, a first electrode which receives a masking enable signal and a second electrode connected to a second node, a fourth transistor including a control electrode which receives a power voltage, a first electrode connected to the second node and a second electrode connected to a third control node, a fifth transistor including a control electrode connected to the second control node, a first electrode which receives the first clock signal and a second electrode connected to a third node, a sixth transistor including a control electrode connected to the third control node, a first electrode connected to a first node and a second electrode which receives the second clock signal, a seventh transistor including a control electrode which receives the second clock signal, a first electrode connected to the first node and a second electrode connected to a first control node, an eighth transistor including a control electrode which receives the power voltage, a first electrode connected to the fifth node and a second electrode connected to the second control node, a ninth transistor including a control electrode connected to the first control node, a first electrode which receives the first clock signal and a second electrode connected to a gate output terminal, a tenth transistor including a control electrode connected to the second control node, a first electrode connected to the gate output terminal and a second electrode which receives the power voltage, an eleventh transistor including a control electrode connected to the second control node, a first electrode which receives the first clock signal and a second electrode connected to the first control node and a twelfth transistor including a control electrode which receives the masking enable signal, a first electrode connected to the third node and a second electrode connected to the second node.

In an embodiment, the gate driver may further include a first capacitor including a first electrode which receives the first clock signal and a second electrode connected to the first control node, a second capacitor including a first electrode connected to the third control node and a second electrode connected to the first node and a third capacitor including a first electrode connected to the second control node and a second electrode connected to the fourth node.

In an embodiment, in a state in which the masking enable signal has an inactive level, the gate output terminal may output a gate output signal. In a state in which the masking enable signal has an active pulse, the gate output terminal may not output the gate output signal.

In an embodiment of a display apparatus according to the inventive concept, the display apparatus includes a display panel, a gate driver and a data driver. The display panel includes a pixel. The gate driver outputs a gate output signal to the pixel. The data driver outputs a data voltage to the pixel. The gate driver includes a pull-up circuit which outputs a first clock signal as the gate output signal in response to a voltage of a first control node, a pull-down circuit which pulls down the gate output signal to a power voltage in response to a voltage of a second control node, a first control circuit which applies the first clock signal to the first control node in response to the voltage of the second control node, a second control circuit which controls a voltage of the first control node in response to a voltage of a third control node and a second clock signal and a third control circuit which applies a masking enable signal to the third control node in response to the first clock signal.

In an embodiment, the gate driver may further include a fourth control circuit which controls the voltage of the third control node using the first clock signal in response to the voltage of the second control node and a short preventing circuit which prevents a short between the first clock signal and the voltage of the third control node. The fourth control circuit may include a fifth transistor including a control electrode connected to the second control node, a first electrode which receives the first clock signal and a second electrode connected to a third node. The short preventing circuit may include a twelfth transistor including a control electrode which receives the masking enable signal, a first electrode connected to the third node and a second electrode connected to a second node.

In an embodiment, in a state in which the masking enable signal has an inactive level, a gate output terminal may output the gate output signal. In a state in which the masking enable signal has an active pulse, the gate output terminal may not output the gate output signal.

According to the gate driver and the display apparatus including the gate driver, the gate driver includes the third control circuit controlling the voltage of the third control node based on the masking enable signal so that the multiple division of the driving frequency may be supported. Thus, the power consumption of the display apparatus may be effectively reduced by the multiple division of the driving frequency.

In addition, the gate driver includes the short preventing circuit preventing the short between the first clock signal and the voltage of the third control node so that the reliability of the gate driver may be enhanced.

### BRIEF DESCRIPTION OF THE DRAWINGS

The above and other features and advantages of the inventive concept will become more apparent by describing in detailed embodiments thereof with reference to the accompanying drawings, in which:

FIG. 1 is a block diagram illustrating an embodiment of a display apparatus according to the inventive concept;

FIG. 2 is a diagram illustrating driving frequencies of the display panel of FIG. 1;

FIG. 3 is a circuit diagram illustrating an embodiment of a pixel of the display panel of FIG. 1;

FIG. 4 is a timing diagram illustrating driving signals of the pixel of FIG. 3 in a variable frequency driving method;

FIG. 5 is a diagram illustrating a gate driver of FIG. 1;

FIG. 6 is a diagram illustrating driving frequencies for areas of the display panel of FIG. 1 in a multiple frequency driving method;

FIG. 7 is a circuit diagram illustrating a stage of the gate driver of FIG. 5;

FIG. 8 is a timing diagram illustrating input signals and an output signal of the stage of FIG. 7 when a masking enable signal has an inactive level;

FIG. 9 is a timing diagram illustrating the input signals and the output signal of the stage of FIG. 7 when the masking enable signal has an active pulse;

FIG. 10 is a timing diagram illustrating the input signals, node signals and the output signal of the stage of FIG. 7 when the masking enable signal has the inactive level;

FIG. 11 is a timing diagram illustrating the input signals, the node signals and the output signal of the stage of FIG. 7 when the masking enable signal has the active pulse;

FIG. 12 is a block diagram illustrating an embodiment of an electronic apparatus according to the inventive concept;

FIG. 13 is a diagram illustrating an embodiment in which the electronic apparatus of FIG. 12 is implemented as a smart phone; and

FIG. 14 is a block diagram illustrating an embodiment of an electronic apparatus according to the inventive concept.

### DETAILED DESCRIPTION

Hereinafter, the inventive concept will be explained in detail with reference to the accompanying drawings.

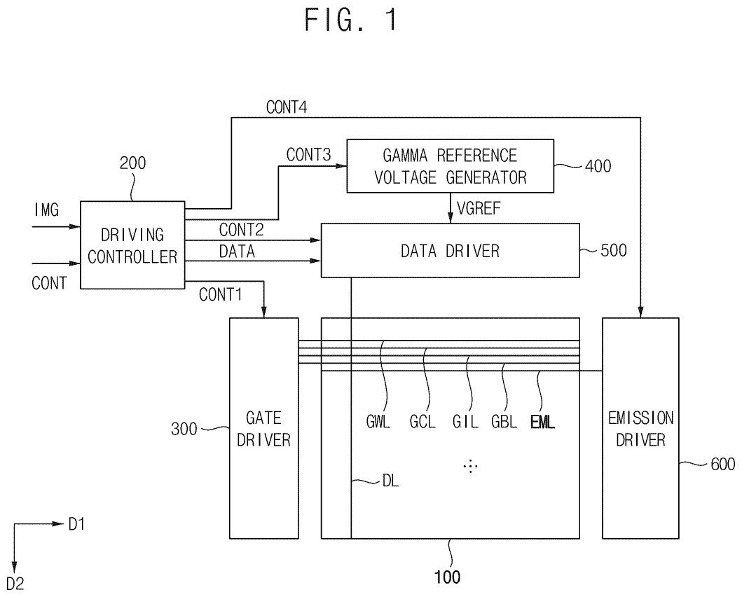

FIG. 1 is a block diagram illustrating an embodiment of a display apparatus according to the inventive concept.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Referring to FIG. 1, the display apparatus includes a display panel 100 and a display panel driver. The display panel driver includes a driving controller 200, a gate driver 300, a gamma reference voltage generator 400, a data driver 500 and an emission driver 600.

The display panel 100 has a display region on which an image is displayed and a peripheral region adjacent to the display region.

The display panel 100 includes a plurality of gate lines GWL, GCL, GIL and GBL, a plurality of data lines DL, a plurality of emission lines EML and a plurality of pixels electrically connected to the gate lines GWL, GCL, GIL and GBL, the data lines DL and the emission lines EML. The gate lines GWL, GCL, GIL and GBL may extend in a first direction D1, the data lines DL may extend in a second direction D2 crossing the first direction DI and the emission lines EML may extend in the first direction D1.

The driving controller 200 receives input image data IMG and an input control signal CONT from an external apparatus. In an embodiment, the input image data IMG may include red image data, green image data and blue image data, for example. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONTI to the gate driver 300. The first control signal CONTI may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals driving the gate lines GWL, GCL, GIL and GBL in response to the first control signal CONT1 received from the driving controller 200. The gate driver 300 may sequentially output the gate signals to the gate lines GWL, GCL, GIL and GBL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

The emission driver 600 generates emission signals to drive the emission lines EML in response to the fourth control signal CONT4 received from the driving controller 200. The emission driver 600 may output the emission signals to the emission lines EML.

Although the gate driver 300 is disposed at a first side (e.g., left side in FIG. 1) of the display panel 100 and the emission driver 600 is disposed at a second side (e.g., right side in FIG. 1) of the display panel 100 opposite to the first side in FIG. 1 for convenience of explanation, the inventive concept may not be limited thereto. In an embodiment, both of the gate driver 300 and the emission driver 600 may be disposed at the first side of the display panel 100, for example. In an embodiment, the gate driver 300 and the emission driver 600 may be disposed at opposite sides of the display panel 100, for example. In an embodiment, the gate driver 300 and the emission driver 600 may be unitary.

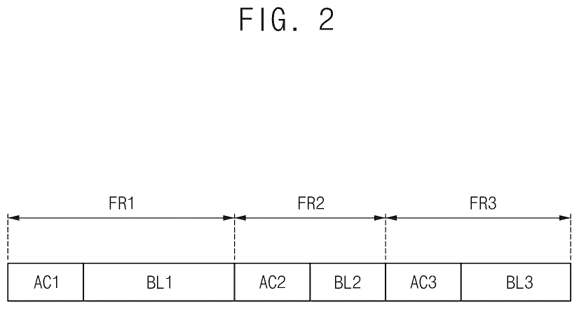

FIG. 2 is a diagram illustrating driving frequencies of the display panel 100 of FIG. 1.

Referring to FIGS. 1 and 2, the display panel 100 may be driven in variable frequencies. A first frame FR1 having a first frequency may include a first active period AC1 and a first blank period BL1. A second frame FR2 having a second frequency different from the first frequency may include a second active period AC2 and a second blank period BL2. A third frame FR3 having a third frequency different from the first frequency and the second frequency may include a third active period AC3 and a third blank period BL3.

The first active period AC1 may have a time length same as a time length of the second active period AC2. The first blank period BL1 may have a time length different from a time length of the second blank period BL2.

The second active period AC2 may have a time length same as a time length of the third active period AC3. The second blank period BL2 may have a time length different from a time length of the third blank period BL3.

A driving timing of the display apparatus may include a data writing period, when the data voltage is written in the pixel and the light-emitting element emits a light, and a self scan period, when the data voltage is not written in the pixel and the light-emitting element emits a light. The data writing period may be disposed in the active periods AC1, AC2 and AC3. The self scan period may be disposed in the blank periods BL1, BL2 and BL3.

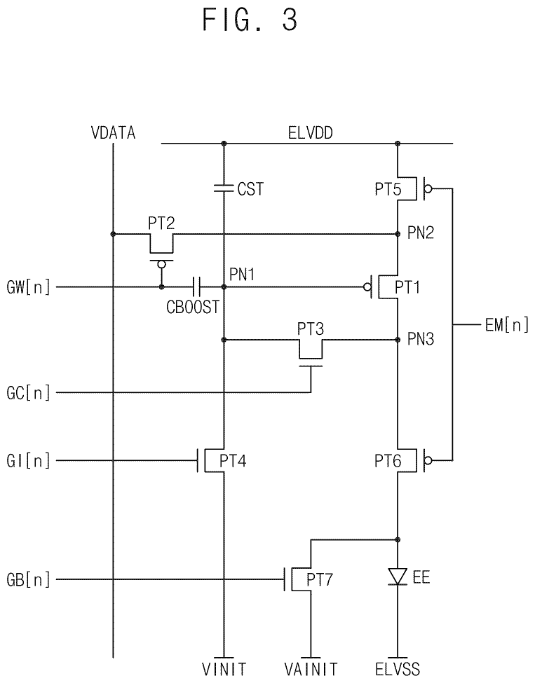

FIG. 3 is a circuit diagram illustrating an embodiment of a pixel of the display panel 100 of FIG. 1.

Referring to FIGS. 1 to 3, the display panel 100 includes a plurality of pixels. Each of the pixels includes a light-emitting element EE.

The pixel receives a data writing gate signal GW, a compensation gate signal GC, a data initialization gate signal GI, a light-emitting element initialization gate signal GB, the data voltage VDATA and the emission signal EM and the light-emitting element EE of the pixel emits light corresponding to the level of the data voltage VDATA to display the image.

In the illustrated embodiment, the pixel may include a switching element of a first type and a switching element of a second type different from the first type. In an embodiment, the switching element of the first type may be a polysilicon thin film transistor, for example. In an embodiment, the switching element of the first type may be a relatively low temperature polysilicon (“LTPS”) thin film transistor, for example. In an embodiment, the switching element of the second type may be an oxide semiconductor thin film transistor, for example. In an embodiment, the switching element of the first type may be a P-type transistor and the switching element of the second type may be an N-type transistor, for example.

At least one of the pixels may include first to seventh pixel switching elements PT1 to PT7 and the light-emitting element EE.

The pixel may include a first pixel switching element PT1 including a control electrode connected to a first pixel node PN1, a first electrode connected to a second pixel node PN2 and a second electrode connected to a third pixel node PN3, a second pixel switching element PT2 including a control electrode receiving the data writing gate signal GW[n], a first electrode receiving the data voltage VDATA and a second electrode connected to the second pixel node PN2, a third pixel switching element PT3 including a control electrode receiving the compensation gate signal GC[n], a first electrode connected to the first pixel node PN1 and a second electrode connected to the third pixel node PN3, a fourth pixel switching element PT4 including a control electrode receiving the data initialization gate signal GI[n], a first electrode receiving an initialization voltage VINIT and a second electrode connected to the first pixel node PN1, a fifth pixel switching element PT5 including a control electrode receiving the emission signal EM[n], a first electrode receiving a pixel high power voltage ELVDD having a relative high power voltage level and a second electrode connected to the second pixel node PN2, a sixth pixel switching element PT6 including a control electrode receiving the emission signal EM[n], a first electrode connected to the third pixel node PN3 and a second electrode connected to an anode electrode of the light-emitting element EE, a seventh pixel switching element PT7 including a control electrode receiving the light-emitting element initialization gate signal GB[n], a first electrode receiving a light-emitting element initialization voltage VAINIT and a second electrode connected to the anode electrode of the light-emitting element EE and the light-emitting element EE including the anode electrode and a cathode electrode receiving a pixel low power voltage ELVSS having a relative low power voltage level. Here, n may be a natural number.

The pixel may further include a storage capacitor CST including a first electrode receiving the pixel high power voltage ELVDD and a second electrode connected to the first pixel node PN1. The pixel may further include a boosting capacitor CBOOST including a first electrode receiving the data writing gate signal GW[n] and a second electrode connected to the first pixel node PN1.

A driving current may flow through the fifth pixel switching element PT5, the first pixel switching element PT1 and the sixth pixel switching element PT6 to drive the light-emitting element EE. An intensity of the driving current may be determined by the level of the data voltage VDATA. A luminance of the light-emitting element EE may be determined by the intensity of the driving current.

In the illustrated embodiment, when the image displayed on the display panel 100 is a static image or the display panel is operated in always on mode, a driving frequency of the display panel 100 may be decreased to reduce a power consumption. When all of the switching elements of the pixel of the display panel 100 are polysilicon thin film transistors, a flicker may be generated due to a leakage current of the pixel switching element in the relatively low frequency driving mode. Thus, some of the pixel switching elements may be the oxide semiconductor thin film transistors. In the embodiment, the third pixel switching element PT3, the fourth pixel switching element PT4 and the seventh pixel switching element PT7 may be the oxide semiconductor thin film transistors. The first pixel switching element PT1, the second pixel switching element PT2, the fifth pixel switching element PT5 and the sixth pixel switching element PT6 may be the polysilicon thin film transistors.

Although some of the pixel switching elements are the oxide semiconductor thin film transistors and other pixel switching elements are the polysilicon thin film transistors in the illustrated embodiment, the inventive concept may not be limited thereto. The inventive concept may be applied to the pixel including only the oxide semiconductor thin film transistors. Although some of the pixel switching elements are the N-type transistors and other pixel switching elements are the P-type transistors in the illustrated embodiment, the inventive concept may not be limited thereto. The inventive concept may be applied to the pixel including only the N-type transistors.

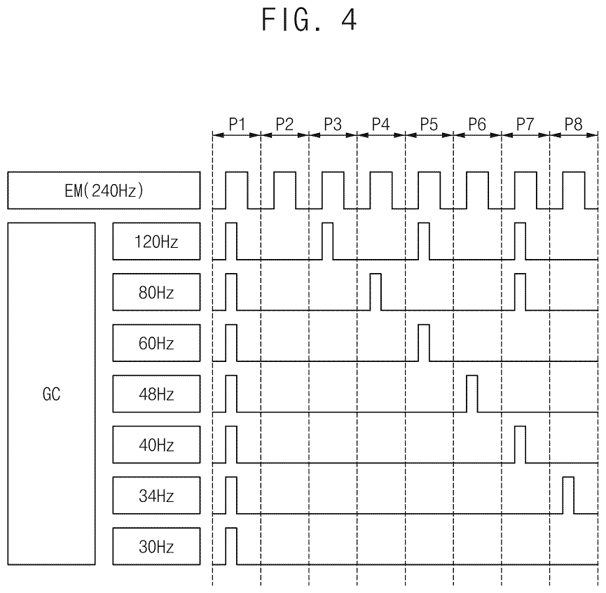

FIG. 4 is a timing diagram illustrating driving signals of the pixel of FIG. 3 in a variable frequency driving method.

Referring to FIGS. 1 to 4, the display panel 100 may be driven in the variable frequencies. In an embodiment, a maximum driving frequency of the display panel 100 may be 120 hertz (Hz), for example. When the display panel 100 is driven in the driving frequency of 120 Hz, the compensation gate signal GC may have active pulses in a first period P1, a third period P3, a fifth period P5 and a seventh period P7 and a data writing operation and a compensation operation may be operated in the first period P1, the third period P3, the fifth period P5 and the seventh period P7. Although the compensation gate signal GC has active pulses in the first period P1, the third period P3, the fifth period P5 and the seventh period P7 in FIG. 4 for convenience of explanation, the data writing operation and the compensation operation may continue for two periods of FIG. 4. In an embodiment, when the display panel 100 is driven in 120 Hz, a first data writing operation and a first compensation operation may be operated in first and second periods P1 and P2, a second data writing operation and a second compensation operation may be operated in third and fourth periods P3 and P4, a third data writing operation and a third compensation operation may be operated in fifth and sixth periods P5 and P6 and a fourth data writing operation and a fourth compensation operation may be operated in seventh and eighth periods P7 and P8, for example. Although not shown in FIG. 4, the data writing gate signal GW may have active pulses in periods when the compensation gate signal GC has the active pulses. The third pixel switching element PT3 including the control electrode receiving the compensation gate signal GC is the N-type transistor so that the active pulse of the compensation gate signal GC may be a relatively high pulse. In contrast, the second pixel switching element PT2 including the control electrode receiving the data writing gate signal GW is the P-type transistor so that the active pulse of the data writing gate signal GW may be a relatively low pulse.

When the display panel 100 is driven in the driving frequency of 80 Hz, the compensation gate signal GC may have active pulses in the first period P1, the fourth period P4 and the seventh period P7 and the data writing operation and the compensation operation may be operated in the first period P1, the fourth period P4 and the seventh period P7. The data writing operation and the compensation operation may continue for two periods of FIG. 4. In an embodiment, when the display panel 100 is driven in 80 Hz, a first data writing operation and a first compensation operation may be operated in the first and second periods P1 and P2, a second data writing operation and a second compensation operation may be operated in the fourth and fifth periods P4 and P5 and a third data writing operation and a third compensation operation may be operated in the seventh and eighth periods P7 and P8, for example.

When the display panel 100 is driven in the driving frequency of 60 Hz, the compensation gate signal GC may have active pulses in the first period P1 and the fifth period P5 and the data writing operation and the compensation operation may be operated in the first period P1 and the fifth period P5. The data writing operation and the compensation operation may continue for two periods of FIG. 4. In an embodiment, when the display panel 100 is driven in 60 Hz, a first data writing operation and a first compensation operation may be operated in the first and second periods P1 and P2 and a second data writing operation and a second compensation operation may be operated in the fifth and sixth periods P5 and P6, for example.

When the display panel 100 is driven in the driving frequency of 120 Hz, a light-emitting operation EM of the light-emitting element EE may be operated in 240 Hz. When the display panel 100 is driven in 120 Hz and the light-emitting operation EM is driven in 240 Hz, the display panel 100 may be also referred to as operating in two cycles.

When the display panel 100 is driven in the driving frequency of 60 Hz, the light-emitting operation EM of the light-emitting element EE may be operated in 240 Hz. When the display panel 100 is driven in 60 Hz and the light-emitting operation EM is driven in 240 Hz, the display panel 100 may be also referred to as operating in four cycles.

In the display apparatus supporting the variable frequency driving, a driving sequence of the display panel 100 may include an address scan period and a self scan period. In the address scan period, the data voltage may be written to the pixel. In the self scan period, the data voltage may not be written to the pixel and only light emission may be operated. In the self scan period, the data voltage may not be written to the pixel but the light-emitting operation EM of the light-emitting element EE may be operated. The first period P1 of FIG. 4 is an embodiment of the address scan period and the second period P2 of FIG. 4 is an embodiment of the self scan period.

When the display panel 100 is driven in the driving frequency of 48 Hz, the compensation gate signal GC may have active pulses in the first period P1 and the sixth period P6 and the data writing operation and the compensation operation may be operated in the first period P1 and the sixth period P6.

When the display panel 100 is driven in the driving frequency of 40 Hz, the compensation gate signal GC may have active pulses in the first period P1 and the seventh period P7 and the data writing operation and the compensation operation may be operated in the first period P1 and the seventh period P7.

When the display panel 100 is driven in the driving frequency of about 34 Hz, the compensation gate signal GC may have active pulses in the first period P1 and the eighth period P8 and the data writing operation and the compensation operation may be operated in the first period P1 and the eighth period P8.

When the display panel 100 is driven in the driving frequency of 30 Hz, the compensation gate signal GC may have active pulses in the first period P1 and a ninth period and the data writing operation and the compensation operation may be operated in the first period P1 and the ninth period.

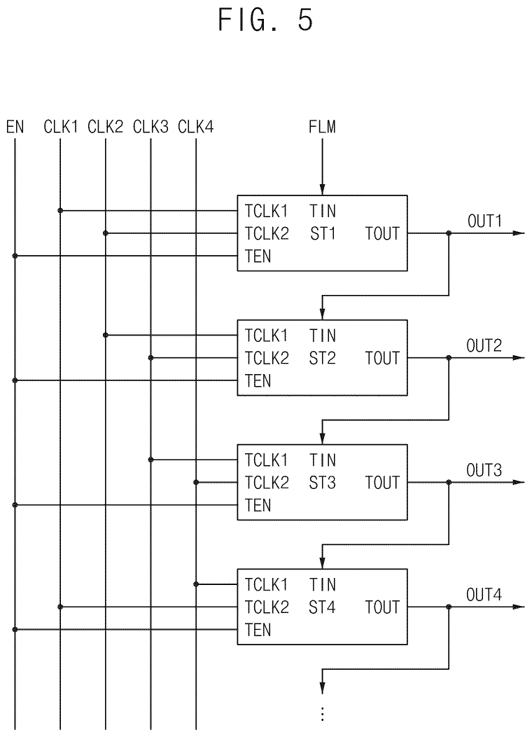

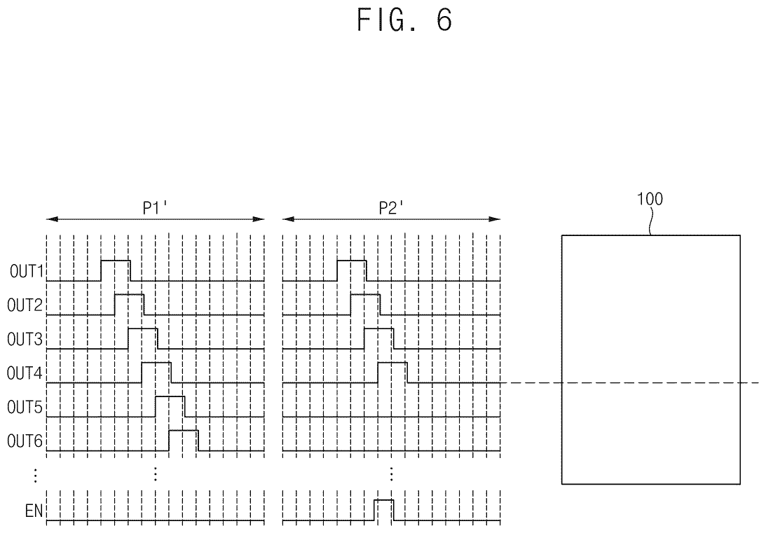

FIG. 5 is a diagram illustrating the gate driver 300 of FIG. 1. FIG. 6 is a diagram illustrating driving frequencies for areas of the display panel 100 of FIG. 1 in a multiple frequency driving (“MFD”) method.

Referring to FIGS. 1 to 6, the gate driver 300 may include a plurality of stages ST1, ST2, ST3, ST4, . . . , etc.

The stages ST1, ST2, ST3, ST4, . . . , etc., may receive a first clock signal CLK1, a second clock signal CLK2, a third clock signal CLK3, a fourth clock signal CLK4 and a masking enable signal EN. The stages ST1, ST2, ST3, ST4, . . . , etc., may output gate output signals OUT1, OUT2, OUT3, OPU4, . . . , etc.

An input signal of the first stage ST1 is a vertical start signal FLM, an input signal of the second stage ST2 is the gate output signal OUT1 of the first stage ST1, an input signal of the third stage ST3 is the gate output signal OUT2 of the second stage ST2 and an input signal of the fourth stage ST4 is the gate output signal OUT3 of the third stage ST3.

The stages ST1, ST2, ST3, ST4, . . . , etc., may include an input terminal TIN receiving the input signal, a first clock terminal TCLK1 receiving one of the first to fourth clock signals CLK1 to CLK4, a second clock terminal TCLK2 receiving another one of the first to fourth clock signals CLK1 to CLK4, a masking enable terminal TEN receiving the masking enable signal EN and an output terminal TOUT outputting the gate output signal.

The first to fourth clock signals CLK1 to CLK4 may have different phases from each other. In an embodiment, the first clock signal CLK1 may be applied to the first clock terminal TCLK1 of the first stage ST1 and the second clock signal CLK2 may be applied to the second clock terminal TCLK2 of the first stage ST1, for example. In an embodiment, the second clock signal CLK2 may be applied to the first clock terminal TCLK1 of the second stage ST2 and the third clock signal CLK3 may be applied to the second clock terminal TCLK2 of the second stage ST2, for example. In an embodiment, the third clock signal CLK3 may be applied to the first clock terminal TCLK1 of the third stage ST3 and the fourth clock signal CLK4 may be applied to the second clock terminal TCLK2 of the third stage ST3, for example. In an embodiment, the fourth clock signal CLK4 may be applied to the first clock terminal TCLK1 of the fourth stage ST4 and the first clock signal CLK1 may be applied to the second clock terminal TCLK2 of the fourth stage ST4, for example.

A pulse of the gate output signal OUT1 of the first stage ST1 may be synchronized with a pulse of the first clock signal CLK1. A pulse of the gate output signal OUT2 of the second stage ST2 may be synchronized with a pulse of the second clock signal CLK2. A pulse of the gate output signal OUT3 of the third stage ST3 may be synchronized with a pulse of the third clock signal CLK3. A pulse of the gate output signal OUT4 of the fourth stage ST4 may be synchronized with a pulse of the fourth clock signal CLK4.

In an embodiment, the gate output signals OUT1, OUT2, OUT3, OUT4, . . . may be the compensation gate signals GC[n] or the data initialization gate signal GI[n].

An MFD may be operated by driving frequencies for areas of the display panel 100. The stages ST1, ST2, ST3, ST4, . . . , etc., may selectively output the gate output signals OUT1, OUT2, OUT3, OUT4, . . . according to the masking enable signal EN.

In an embodiment, when the masking enable signal EN has an inactive level, the gate output terminal TOUT may output a gate output signal, for example. In contrast, when the masking enable signal EN has an active pulse, the gate output terminal TOUT may not output the gate output signal.

As shown in FIG. 6, the masking enable signal EN has the inactive level in a first period P1′ so that a first gate output signal OUT1, a second gate output signal OUT2, a third gate output signal OUT3, a fourth gate output signal OUT4, a fifth gate output signal OUT5 and a sixth gate output signal OUT6 may be sequentially outputted in the first period P1′.

The masking enable signal EN has an active pulse while a pulse of the third gate output signal OUT3 is outputted and a pulse of the fourth gate output signal OUT4 is outputted in a second period P2′. In the second period P2′, a fifth stage receives the fourth gate output signal OUT4 and the fifth stage may not output the fifth gate output signal OUT5 by the active pulse of the masking enable signal EN. The fifth gate output signal OUT5 is not transmitted to a sixth stage so that the sixth stage may not output the sixth gate output signal OUT6.

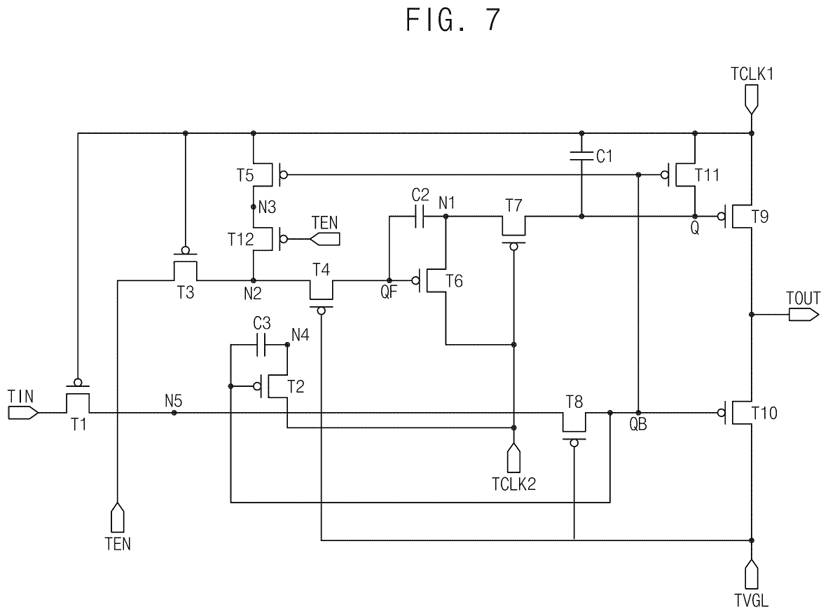

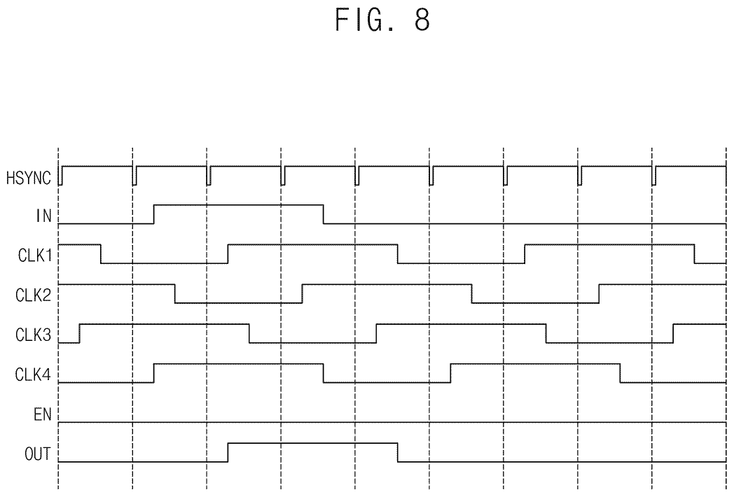

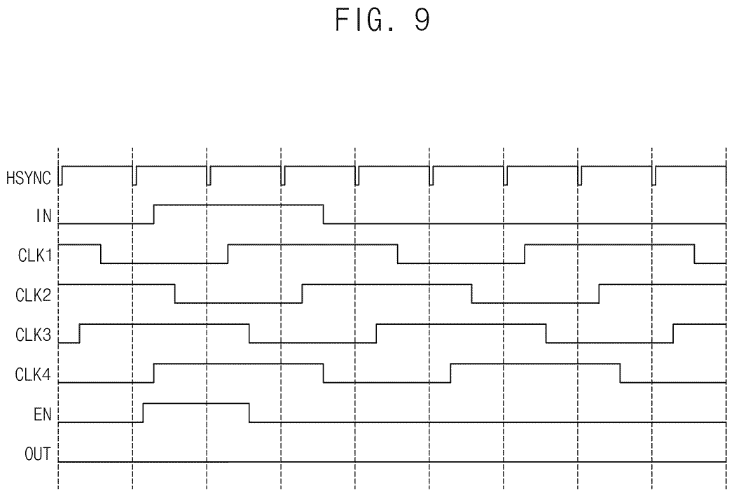

FIG. 7 is a circuit diagram illustrating a stage of the gate driver 300 of FIG. 5. FIG. 8 is a timing diagram illustrating input signals and an output signal of the stage of FIG. 7 when the masking enable signal EN has the inactive level. FIG. 9 is a timing diagram illustrating the input signals and the output signal of the stage of FIG. 7 when the masking enable signal EN has the active pulse.

Referring to FIGS. 1 to 9, the gate driver 300 may include a pull-up circuit, a pull-down circuit, a first control circuit, a second control circuit and a third control circuit.

For convenience of explanation, the first clock signal CLK1 is applied to the first clock terminal TCLK1 of the stage of FIG. 7 and the second clock signal CLK2 is applied to the second clock terminal TCLK2 of the stage of FIG. 7. The gate driver 300 may further include a power voltage terminal TVGL and a power voltage may be applied to the power voltage terminal TVGL. In an embodiment, the power voltage may be the pixel high power voltage ELVDD or the pixel low power voltage ELVSS, but is not limited thereto, and may be another power voltage.

The pull-up circuit may output the first clock signal CLK1 as the gate output signal OUT in response to a voltage of a first control node Q. The pull-up circuit may include a ninth transistor T9 including a control electrode connected to the first control node Q, a first electrode connected to the first clock terminal TCLK1 receiving the first clock signal CLK1 and a second electrode connected to a gate output terminal TOUT.

The pull-down circuit may pull down the gate output signal OUT in response to a voltage of a second control node QB. The pull-down circuit may include a tenth transistor T10 including a control electrode connected to the second control node QB, a first electrode connected to the gate output terminal TOUT and a second electrode connected to the power voltage terminal TVGL receiving the power voltage.

The first control circuit may apply the first clock signal CLK1 to the first control node Q in response to the voltage of the second control node QB. The first control circuit may include an eleventh transistor T11 including a control electrode connected to the second control node QB, a first electrode connected to the first clock terminal TCLK1 receiving the first clock signal CLK1 and a second electrode connected to the first control node Q.

The second control circuit may control the voltage of the first control node Q in response to a voltage of a third control node QF and the second clock signal CLK2. The second control circuit may include a sixth transistor T6 including a control electrode connected to the third control node QF, a first electrode connected to a first node NI and a second electrode connected to the second clock terminal TCLK2 receiving the second clock signal CLK2 and a seventh transistor T7 including a control electrode connected to the second clock terminal TCLK2 receiving the second clock signal CLK2, a first electrode connected to the first node N1 and a second electrode connected to the first control node Q. The second control circuit may further include a second capacitor C2 including a first electrode connected to the third control node QF and a second electrode connected to the first node N1.

The third control circuit may apply the masking enable signal EN to the third control node QF in response to the first clock signal CLK1. The third control circuit may include a third transistor T3 including a control electrode connected to the first clock terminal TCLK1 receiving the first clock signal CLK1, a first electrode connected to the masking enable terminal TEN receiving the masking enable signal EN and a second electrode connected to a second node N2.

The gate driver 300 may further include a fourth transistor T4 including a control electrode connected to the power voltage terminal TVGL receiving the power voltage, a first electrode connected to the second node N2 and a second electrode connected to the third control node QF.

The gate driver 300 may further include a fourth control circuit controlling the voltage of the third control node QF using the first clock signal CLK1 in response to the voltage of the second control node QB. In addition, the gate driver 300 may further include a short preventing circuit preventing a short between the first clock signal CLK1 and the voltage of the third control node QF.

The fourth control circuit may include a fifth transistor T5 including a control electrode connected to the second control node QB, a first electrode connected to the first clock terminal TCLK1 receiving the first clock signal CLK1 and a second electrode connected to a third node N3. In addition, the short preventing circuit may include a twelfth transistor T12 including a control electrode connected to the masking enable terminal TEN receiving the masking enable signal EN, a first electrode connected to the third node N3 and a second electrode connected to the second node N2.

The gate driver 300 may further include a fifth control circuit controlling the voltage of the second control node QB using the second clock signal CLK2 in response to the voltage of the second control node QB. The fifth control circuit may include a second transistor T2 including a control electrode connected to the second control node QB, a first electrode connected to a fourth node N4 and a second electrode connected to the second clock terminal TCLK2 receiving the second clock signal CLK2 and a third capacitor C3 including a first electrode connected to the second control node QB and a second electrode connected to the fourth node N4.

The gate driver 300 may further include an input circuit applying an input signal IN to the second control node QB in response to the first clock signal CLK1. The input circuit may include a first transistor T1 including a control electrode connected to the first clock terminal TCLK1 receiving the first clock signal CLK1, a first electrode connected to the input terminal TIN receiving the input signal IN and a second electrode connected to a fifth node N5 and an eighth transistor T8 including a control electrode connected to the power voltage terminal TVGL receiving the power voltage, a first electrode connected to the fifth node N5 and a second electrode connected to the second control node QB.

The gate driver 300 may further include a first capacitor C1 including a first electrode connected to the first clock terminal TCLK1 receiving the first clock signal CLK1 and a second electrode connected to the first control node Q.

In an embodiment, in FIG. 7, the first to twelfth transistors T1 to T12 may be P-type transistors, for example. In an embodiment, in FIG. 7, the first to twelfth transistors T1 to T12 may be poly silicon thin film transistors, for example.

In FIGS. 8 and 9, HSYNC may indicate a vertical synchronizing signal. HSYNC may represent a horizontal line period.

In FIG. 8, the masking enable signal EN has the inactive level, the gate output terminal TOUT may output the gate output signal OUT.

In contrast, in FIG. 9, the masking enable signal EN has the active pulse, the gate output terminal TOUT may not output the gate output signal OUT.

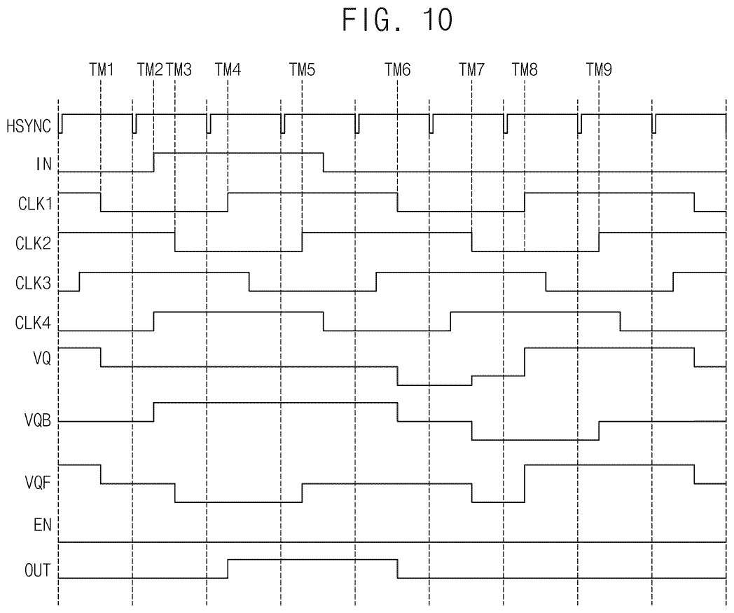

FIG. 10 is a timing diagram illustrating the input signals, node signals and the output signal of the stage of FIG. 7 when the masking enable signal EN has the inactive level.

In FIG. 10, VQ indicates the voltage of the first control node Q, VQB indicates the voltage of the second control node QB and VQF indicates the voltage of the third control node QF.

Hereinafter, the operation of the stage when the masking enable signal EN has the inactive level may be described in detail referring to FIG. 10.

In a first time point TM1, when the first clock signal becomes a relatively low level, the first transistor T1 is turned on and a relatively low level of the input signal IN may be applied to the second control node QB through the eighth transistor T8.

In the first time point TM1, the tenth transistor T10, the eleventh transistor T11 and the fifth transistor T5 may be turned on in response to the relatively low level of the input signal IN which is applied to the second control node QB.

In the first time point TM1, the eleventh transistor T11 is turned on so that a relatively low level of the first clock signal CLK1 may be applied to the first control node Q.

In the first time point TM1, the ninth transistor T9 is turned on in response to the relatively low level of the first clock signal CLK1 which is applied to the first control node Q so that the relatively low level of the first clock signal CLK1 may be outputted as the gate output signal OUT.

In addition, in the first time point TM1, the tenth transistor T10 is turned on so that the power voltage having a relatively low level may be outputted as the gate output signal OUT.

In addition, in the first time point TM1, when the first clock signal CLK1 becomes the relatively low level, the third transistor T3 may be turned on and a relatively low level of the masking enable signal EN may be applied to the third control node QF through the fourth transistor T4. In addition, in the first time point TM1, the relatively low level of the first clock signal CLK1 may be applied to the third control node QF through the fifth transistor T5, the twelfth transistor T12 and the fourth transistor T4 which are turned on.

In the first time point TM1, the sixth transistor T6 may be turned on in response to the relatively low level of the masking enable signal EN applied to the third control node QF or the relatively low level of the first clock signal CLK1. In the first time point TM1, the seventh transistor T7 may not be turned on by a relatively high level of the second clock signal CLK2, the voltage of the first electrode QF of the second capacitor C2 has a relatively low level and the voltage of the second electrode N1 of the second capacitor C2 has a relatively high level.

In a second time point TM2, the first clock signal CLK1 maintains the relatively low level and the input signal IN rises from the relatively low level to a relatively high level.

In the second time point TM2, the relatively high level of the input signal IN is applied to the second control node QB through the first transistor T1. In the second time point TM2, the tenth transistor T10, the eleventh transistor T11 and the fifth transistor T5 may be turned off by the relatively high level of the input signal IN which is applied to the second control node QB.

In a third time point TM3, the second clock signal CLK2 falls from the relatively high level to a relatively low level.

In the third time point TM3, the seventh transistor T7 is turned on in response to the relatively low level of the second clock signal CLK2 and the voltage VQF of the third control node QF decreases to a second relatively low level lower than the relatively low level by the second capacitor C2.

In the third time point TM3, the relatively low level of the second clock signal CLK2 is applied to the first control node Q through the sixth transistor T6 and the seventh transistor T7 which are turned on.

In a fourth time point TM4, the first clock signal CLK1 rises from the relatively low level to a relatively high level.

In the fourth time point TM4, the fifth transistor T5 maintains a turned-off state by the voltage VQB of the second control node QB so that the relatively high level of the first clock signal CLK1 may not be transmitted to the third control node QF.

In the fourth time point TM4, the ninth transistor T9 maintains a turned-on state by the voltage VQ of the first control node Q so that the ninth transistor T9 may output the relatively high level of the first clock signal CLK1 as the gate output signal OUT. In the fourth time point TM4, the gate output signal OUT may rise.

In the fourth time point TM4, the sixth transistor T6 maintains a turned-on sate by the voltage VQF of the third control node QF so that the relatively low level of the second clock signal CLK2 is applied to the first control node Q through the sixth transistor T6 and the seventh transistor T7. In the fourth time point TM4, a voltage of the first electrode of the first capacitor C1 may be a relatively high level and a voltage of the second electrode of the first capacitor C1 may be a relatively low level.

In a fifth time point TM5, the second clock signal CLK2 rises from the relatively low level to the relatively high level.

In the fifth time point TM5, the second transistor T2 may maintain the turned-off state by the voltage VQB of the second control node QB.

In the fifth time point TM5, the sixth transistor T6 maintains the turned-on sate by the sixth transistor T6 and the seventh transistor T7 may be turned off by the relatively high level of the second clock signal CLK2. In the fifth time point TM5, the voltage VQF of the third control node QF may increase from the second relatively low level to the relatively low level by the sixth transistor T6 and the second capacitor C2.

In a sixth time point TM6, the first clock signal CLK1 falls from the relatively high level to the relatively low level.

In the sixth time point TM6, the first transistor T1 is turned on in response to the relatively low level of the first clock signal CLK1. In the sixth time point TM6, the input signal IN has the relatively low level so that the relatively low level of the input signal IN may be applied to the second control node QB through the first transistor T1.

In the sixth time point TM6, when the relatively low level of the input signal IN is applied to the second control node QB, the tenth transistor T10, the eleventh transistor T11 and the fifth transistor T5 may be turned on.

In the sixth time point TM6, the eleventh transistor T11 is turned on so that the relatively low level of the first clock signal CLK1 may be applied to the first control node Q.

In the sixth time point TM6, the ninth transistor T9 may be turned on in response to the relatively low level of the first clock signal CLK1 which is applied to the first control node Q so that the relatively low level of the first clock signal CLK1 may be outputted as the gate output signal OUT.

In the sixth time point TM6, the tenth transistor T10 is turned on so that the power voltage having the relatively low level may be outputted as the gate output signal OUT. In the sixth time point TM6, the gate output signal OUT may fall.

In the sixth time point TM6, when the first clock signal CLK1 becomes the relatively low level, the third transistor T3 is turned on and the relatively low level of the masking enable signal EN may be applied to the third control node QF through the fourth transistor T4. In addition, in the sixth time point TM6, the relatively low level of the first clock signal CLK1 may be applied to the third control node QF through the fifth transistor T5, the twelfth transistor T12 and the fourth transistor T4 which are turned on.

In the sixth time point TM6, the sixth transistor T6 may be turned on in response to the relatively low level of the masking enable signal EN applied to the third control node QF or the relatively low level of the first clock signal CLK1.

In addition, in the sixth time point TM6, the voltage VQ of the first control node Q may decrease from a relatively low level to a second relatively low level lower than the relatively low level by a bootstrapping of the first capacitor C1.

In a seventh time point TM7, the second clock signal CLK2 falls from the relatively high level to the relatively low level.

In the seventh time point TM7, the seventh transistor T7 is turned on in response to the relatively low level of the second clock signal CLK2 and the voltage VQF of the third control node QF decreases to the second relatively low level lower than the relatively low level by the second capacitor C2. In an alternative embodiment, in the seventh time point TM7, the voltage VQF of the third control node QF may have the relatively low level.

In the seventh time point TM7, the relatively low level of the second clock signal CLK2 is applied to the first control node Q through the sixth transistor T6 and the seventh transistor T7 which are turned on.

In the seventh time point TM7, the second transistor T2 is turned on by the relatively low level of the second control node QB and the voltage VQB of the second control node QB may decrease from the relatively low level to a second relatively low level lower than the relatively low level by the third capacitor C3.

In the seventh time point TM7, when the voltage VQB of the second control node QB decreases to the second relatively low level, the tenth transistor T10 may maintain the turned-on state so that the power voltage is outputted as the gate output signal OUT, and the eleventh transistor T11 may be turned on so that the relatively low level of the first clock signal CLK1 may be applied to the first control node Q.

In the seventh time point TM7, the voltage VQ of the first control node Q has the relatively low level so that the relatively low level of the first clock signal CLK1 may be continuously outputted as the gate output signal OUT.

In an eighth time point TM8, the first clock signal CLK1 rises from the relatively low level to the relatively high level.

Unlike in the third time point TM3, in the eighth time point TM8, the fifth transistor T5 maintains the turned-on state by the voltage VQB of the second control node QB so that the relatively high level of the first clock signal CLK1 is transmitted to the third control node QF.

In the eighth time point TM8, the relatively high level of the first clock signal CLK1 is transmitted to the third control node QF, the sixth transistor T6 is turned off.

In the eighth time point TM8, when the sixth transistor T6 is turned off, the relatively low level of the second clock signal CLK2 is not applied to the first control node Q, and the voltage VQ of the first control node Q and the first node N1 increase to the relatively high level by the seventh transistor T7 which is turned on by the relatively high level of the first clock signal CLK1 applied by the eleventh transistor T11 and the second clock signal CLK2. In addition, a difference between the relatively high level and the relatively low level is charged to both electrodes of the second capacitor C2 by the sixth transistor T6 which is turned off.

In the eighth time point TM8, when the voltage VQ of the first control node Q increases to the relatively high level, the ninth transistor T9 is turned off so that the relatively high level of the first clock signal CLK1 is not outputted as the gate output signal OUT.

In a ninth time point TM9, the second clock signal CLK2 rises from the relatively low level to the relatively high level.

In the ninth time point TM9, the second transistor T2 maintains the turned-on sate by the voltage VQB of the second control node QB and the voltage VQB of the second control node QB increases from the second relatively low level to the relatively low level by the third capacitor C3 while the second clock signal CLK2 becomes the relatively high level.

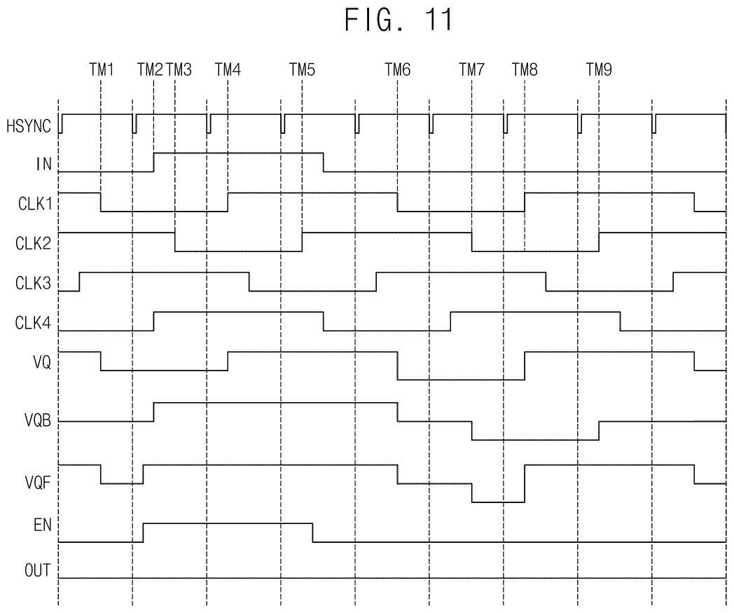

FIG. 11 is a timing diagram illustrating the input signals, the node signals and the output signal of the stage of FIG. 7 when the masking enable signal EN has the active pulse.

In FIG. 11, VQ indicates the voltage of the first control node Q, VQB indicates the voltage of the second control node QB and VQF indicates the voltage of the third control node QF.

Hereinafter, the operation of the stage when the masking enable signal EN has the active pulse may be described in detail referring to FIG. 11.

The circuit operation in the first time point TM1 of FIG. 11 may be the same as the circuit operation in the first time point TM1 of FIG. 10.

The masking enable signal EN has the relatively high level in a second time point TM2 of FIG. 11 and the masking enable signal EN has the relatively low level in the second time point TM2 of FIG. 10 so that the circuit operation in the second time point TM2 of FIG. 11 may be different from the circuit operation in the second time point TM2 of FIG. 10.

In the second time point TM2 of FIG. 11, the relatively high level of the masking enable signal EN may be applied to the third control node QF through the third transistor T3 and the fourth transistor T4.

In the second time point TM2 of FIG. 11, when the relatively high level is applied to the third control node QF, the sixth transistor T6 may be turned off.

In the fourth time point TM4 of FIG. 11, when the first clock signal CLK1 rises from the relatively low level to the relatively high level, the sixth transistor T6 maintains the turned-off state by the voltage VQF of the third control node QF so that the relatively low level of the second clock signal CLK2 may not be applied to the first control node Q.

In addition, in the fourth time point TM4 of FIG. 11, when the first clock signal CLK1 rises from the relatively low level to the relatively high level, the sixth transistor T6 maintains the turned-off state by the voltage VQF of the third control node QF so that the voltage VQ of the first control node Q may increase to the relatively high level again by the first capacitor C1.

In the fourth time point TM4 of FIG. 11, when the voltage VQ of the first control node Q increases to the relatively high level, the ninth transistor T9 is turned off so that the relatively high level of the first clock signal CLK1 is not outputted to the gate output signal OUT.

Therefore, the gate output terminal TOUT of FIG. 11 does not output the gate output signal OUT by the relatively high pulse of the masking enable signal EN applied to the first electrode of the third transistor T3.

As shown in FIG. 10, when the sixth transistor T6 is in the turned-on state in the third time point TM3, the seventh transistor T7 may be turned on in the third time point TM3 in which the second clock signal CLK2 has the relatively low level and the voltage VQF of the third control node QF may decrease to the second relatively low level. In the third time point TM3, when the voltage VQF of the third control node QF decreases to the second relatively low level, the relatively low level may be applied to the first control node Q.

As shown in FIG. 10, when the sixth transistor T6 is in the turned-on state in the fourth time point TM4, the relatively low level of the second clock signal CLK2 is continuously applied to the first control node Q through the sixth transistor T6 and the seventh transistor T7 in the fourth time point TM4 in which the first clock signal CLK1 becomes the relatively high level, and the ninth transistor T9 is turned on so that the relatively high level of the first clock signal CLK1 is outputted as the gate output signal OUT.

As shown in FIG. 11, when the sixth transistor T6 is in the turned-off state in the third time point TM3, the relatively low level is not applied to the first control node Q in the third time point TM3 in which the second clock signal CLK2 has the relatively low level.

As shown in FIG. 11, when the sixth transistor T6 is in the turned-off state in the fourth time point TM4, the relatively low level is not applied to the first control node Q in the fourth time point TM4 in which the first clock signal CLK1 becomes the relatively high level, and the voltage VQ of the first control node Q rises to the relatively high level by the first capacitor C1. In the fourth time point TM4, when the voltage VQ of the first control node Q rises to the relatively high level, the ninth transistor T9 is turned off so that the relatively high level of the first clock signal CLK1 may not be outputted as the gate output signal OUT.

In a duration when the first clock signal CLK1 has the relatively low level, the input signal IN has the relatively low level and the masking enable signal EN has the relatively high level, the twelfth transistor T12 may prevent the short between the relatively low level of the first clock signal CLK1 and the relatively high level of the masking enable signal EN at the second node N2 and the third control node QF.

In the illustrated embodiment, the gate driver 300 includes the third control circuit controlling the voltage VQF of the third control node QF based on the masking enable signal EN so that the multiple division of the driving frequency may be supported. Thus, the power consumption of the display apparatus may be effectively reduced by the multiple division of the driving frequency.

In addition, the gate driver 300 includes the short preventing circuit preventing the short between the first clock signal CLK1 and the voltage of the third control node QF so that the reliability of the gate driver 300 may be enhanced.

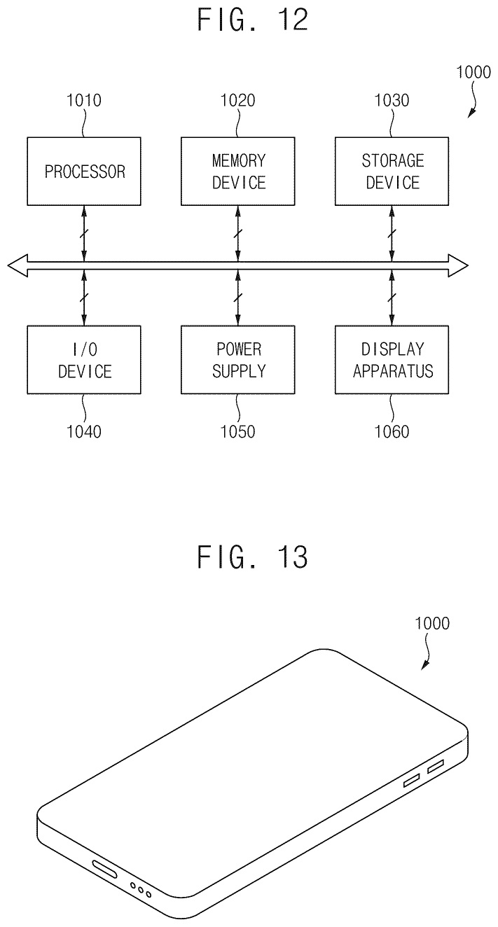

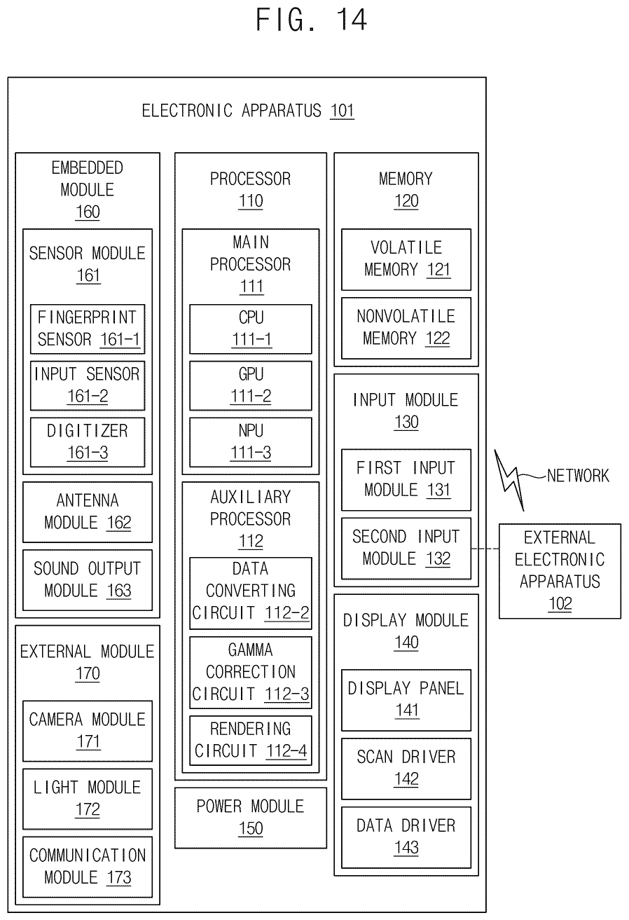

FIG. 12 is a block diagram illustrating an embodiment of an electronic apparatus according to the inventive concept. FIG. 13 is a diagram illustrating an embodiment in which the electronic apparatus of FIG. 12 is implemented as a smart phone.

Referring to FIGS. 12 and 13, the electronic apparatus 1000 may include a processor 1010, a memory device 1020, a storage device 1030, an input/output (“I/O”) device 1040, a power supply 1050 and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (“USB”) device, other electronic apparatuses, etc.

In an embodiment, as illustrated in FIG. 13, the electronic apparatus 1000 may be implemented as a smart phone. However, the electronic apparatus 1000 is not limited thereto. In an embodiment, the electronic apparatus 1000 may be implemented as a cellular phone, a video phone, a smart pad, a smart watch, a tablet personal computer (“PC”), a car navigation system, a computer monitor, a laptop, a head mounted display (“HMD”) device, or the like, for example.

The processor 1010 may perform various computing functions or various tasks. The processor 1010 may be a micro-processor, a central processing unit (“CPU”), an application processor (“AP”), or the like. The processor 1010 may be coupled to other components via an address bus, a control bus, a data bus, etc. Further, the processor 1010 may be coupled to an extended bus such as a peripheral component interconnection (“PCI”) bus.

The processor 1010 may output the input image data IMG and the input control signal CONT to the driving controller 200 of FIG. 1.

The memory device 1020 may store data for operations of the electronic apparatus 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

FIG. 14 is a block diagram illustrating an embodiment of an electronic apparatus 101 according to the inventive concept.

Referring to FIGS. 1 to 14, an electronic apparatus 101 outputs various information through a display module 140 in an operating system. When a processor 110 executes an application stored in a memory 120, the display module 140 provides application information to a user through a display panel 141.

The processor 110 obtains an external input through an input module 130 or a sensor module 161 and executes an application corresponding to the external input. In an embodiment, when the user selects a camera icon displayed on the display panel 141, the processor 110 obtains a user input through an input sensor 161-2 and activates a camera module 171, for example. The processor 110 transfers image data corresponding to a captured image obtained through the camera module 171 to the display module 140. The display module 140 may display an image corresponding to the captured image through the display panel 141.

In an embodiment, when a personal information authentication is executed in the display module 140, a fingerprint sensor 161-1 obtains input fingerprint information as input data. The processor 110 compares input data obtained through the fingerprint sensor 161-1 with authentication data stored in the memory 120, and executes an application according to a comparison result. The display module 140 may display information executed according to application logic through the display panel 141.

In an embodiment, when a music streaming icon displayed on the display module 140 is selected, the processor 110 obtains a user input through the input sensor 161-2 and activates a music streaming application stored in the memory 120. When a music execution command is input in the music streaming application, the processor 110 activates a sound output module 163 to provide sound information corresponding to the music execution command to the user.

In the above, the operation of the electronic apparatus 101 is briefly described. Hereinafter, a configuration of the electronic apparatus 101 is described in detail. Some of elements of the electronic apparatus 101 described later may be integrated and provided as one element, or one element may be separated as two or more elements.

The electronic apparatus 101 may communicate with an external electronic apparatus 102 through a network (e.g., a short-range wireless communication network or a long-range wireless communication network). In an embodiment, the electronic apparatus 101 may include the processor 110, the memory 120, the input module 130, the display module 140, a power module 150, an embedded module 160, and an external module 170. In an embodiment, in the electronic apparatus 101, at least one of the above-described elements may be omitted or one or more other apparatus may be added. In an embodiment, some of the above-described elements (e.g., the sensor module 161, an antenna module 162 or the sound output module 163) may be integrated into another element (e.g., the display module 140).

The processor 110 may execute software to control at least one other element (e.g., hardware or software element) of the electronic apparatus 101 connected to the processor 110 and to perform various data processing or operations. In an embodiment, as at least part of the data processing or the operations, the processor 110 may store receive instructions or data from other elements (e.g., the input module 130, the sensor module 161 or a communication module 173) in a volatile memory 121, may process the instructions or data stored in the volatile memory 121 and may store result data of the processing in a nonvolatile memory 122.

The processor 110 may include a main processor 111 and an auxiliary processor 112. The main processor 111 may include at least one of a CPU 111-1 and an AP. The main processor 111 may further include any one or more of a graphic processing unit (“GPU”) 111-2, a communication processor (“CP”) and an image signal processor (“ISP”). The main processor 111 may further include a neural processing unit (“NPU”) 111-3. The NPU 111-3 is a processor specialized in processing an artificial intelligence model. The artificial intelligence model may be generated through a machine learning. The artificial intelligence model may include a plurality of artificial neural network layers. The artificial neural network may be one of a deep neural network (“DNN”), a convolutional neural network (“CNN”), a recurrent neural network (“RNN”), a restricted boltzmann machine (“RBM”), a deep belief network (“DBN”), a bidirectional recurrent deep neural network (“BRDNN”) and a deep Q-networks or a combination of two or more of the above. However, the artificial neural network is not limited to the above examples. The artificial intelligence model may include software structures, in addition to hardware structures or instead of the hardware structures. At least two of the above-described processing units and the above-described processors may be implemented as an integrated element (e.g., a single chip) or each may be implemented as independent elements (e.g., in a plurality of chips).

The auxiliary processor 112 may include a controller. The controller may include an interface conversion circuit and a timing control circuit. The controller receives an image signal from the main processor 111, converts a data format of the image signal to meet interface specifications with the display module 140, and outputs image data. The controller may output various control signals for driving the display module 140.

The auxiliary processor 112 may further include a data converting circuit 112-2, a gamma correction circuit 112-3 and a rendering circuit 112-4. The data converting circuit 112-2 may receive the image data from the controller and may compensate the image data such that the image is displayed with a desired luminance according to characteristics of the electronic apparatus 101 or a user setting or may convert the image data to reduce a power consumption or compensate for afterimages. The gamma correction circuit 112-3 may convert the image data or a gamma reference voltage such that the image displayed on the electronic apparatus 101 has desired gamma characteristics. The rendering circuit 112-4 may receive the image data from the controller and may render the image data based on a pixel arrangement of the display panel 141 included in the electronic apparatus 101. At least one of the data converting circuit 112-2, the gamma correction circuit 112-3 and the rendering circuit 112-4 may be integrated into another element (e.g., the main processor 111 or the controller). At least one of the data converting circuit 112-2, the gamma correction circuit 112-3 and the rendering circuit 112-4 may be integrated into a data driver 143 to be described later.

The memory 120 may store various data used by at least one element (e.g., the processor 110 or the sensor module 161) of the electronic apparatus 101 and input data or output data for commands related thereto. The memory 120 may include at least one of the volatile memory 121 and the nonvolatile memory 122.

The input module 130 may receive commands or data used to the elements (e.g., the processor 110, the sensor module 161 or the sound output module 163) of the electronic apparatus 101 from the outside of the electronic apparatus 101 (e.g., the user or the external electronic apparatus 102).

The input module 130 may include a first input module 131 for receiving commands or data from the user and a second input module 132 for receiving commands or data from the external electronic apparatus 102. The first input module 131 may include a microphone, a mouse, a keyboard, a key (e.g., a button) or a pen (e.g., a passive pen or an active pen). The second input module 132 may support a designated protocol capable of connecting to the external electronic apparatus 102 by wire or wirelessly. In an embodiment, the second input module 132 may include a high definition multimedia interface (“HDMI”), a USB interface, an SD card interface or an audio interface. The second input module 132 may include a connector physically connected to the external electronic apparatus 102, e.g., an HDMI connector, a USB connector, an SD card connector, or an audio connector (e.g., a headphone connector).

The display module 140 visually provides information to the user. The display module 140 may include the display panel 141, a scan driver 142 and the data driver 143. The display module 140 may further include a window, a chassis and a bracket to protect the display panel 141.

The display panel 141 may include a liquid crystal display panel, an organic light-emitting display panel or an inorganic light-emitting display panel. A type of the display panel 141 is not particularly limited. The display panel 141 may be a rigid type or a flexible type capable of being rolled or folded. The display module 140 may further include a supporter or a heat dissipation member supporting the display panel 141.

The scan driver 142 may be disposed (e.g., mounted) on the display panel 141 as a driving chip. In an alternative embodiment, the scan driver 142 may be integrated on the display panel 141. In an embodiment, the scan driver 142 may include an amorphous silicon TFT gate driver circuit (“ASG”) integrated on the display panel 141, a low temperature polycrystalline silicon (“LTPS”) TFT gate driver circuit integrated on the display panel 141, or an oxide semiconductor TFT gate driver circuit (“OSG”) integrated on the display panel 141, for example. The scan driver 142 receives a control signal from the controller and outputs the scan signals to the display panel 141 in response to the control signal.

The display module 140 may further include a light emission driver. The light emission driver outputs a light emission control signal to the display panel 141 in response to a control signal received from the controller. The light emission driver may be formed independently from the scan driver 142. In an alternative embodiment, the light emission driver and the scan driver 142 may be unitary.

The data driver 143 receives a control signal from the controller, converts the image data into an analog voltage (e.g., the data voltage) and outputs the data voltages to the display panel 141 in response to the control signal.

The data driver 143 may be integrated into another element (e.g., the controller). The functions of the interface conversion circuit and the timing control circuit of the controller described above may be integrated into the data driver 143.

The display module 140 may further include a voltage generating circuit. The voltage generating circuit may output various voltages for driving the display panel 141.

The power module 150 supplies power to elements of the electronic apparatus 101. The power module 150 may include a battery which supplies a power voltage. The battery may include a non-rechargeable primary cell, a rechargeable secondary cell or a fuel cell. The power module 150 may include a power management integrated circuit (“PMIC”). The PMIC supplies optimized power to each of the above-described modules and modules described later. The power module 150 may include a wireless power transmission/reception member electrically connected to the battery. The wireless power transmission/reception member may include a plurality of antenna radiators in a form of coils.

The electronic apparatus 101 may further include the embedded module 160 and the external module 170. The embedded module 160 may include the sensor module 161, the antenna module 162 and the sound output module 163. The external module 170 may include the camera module 171, a light module 172 and the communication module 173.

The sensor module 161 may detect an input by a user's body or an input by the pen among the first input module 131, and generate an electrical signal or data value corresponding to the input. The sensor module 161 may include at least one of the fingerprint sensor 161-1, the input sensor 161-2 and a digitizer 161-3.

The fingerprint sensor 161-1 may generate a data value corresponding to a user's fingerprint. The fingerprint sensor 161-1 may include one of an optical fingerprint sensor or a capacitive fingerprint sensor.

The input sensor 161-2 may generate data values corresponding to coordinate information of the input by the user's body or the input by the pen. The input sensor 161-2 generates a capacitance change due to an input as a data value. The input sensor 161-2 may detect an input by the passive pen or transmit/receive data to/from the active pen.

The input sensor 161-2 may measure bio signals such as a blood pressure, a moisture, or a body fat. In an embodiment, when a user touches a part of his body to a sensor layer or a sensing panel and does not move for a predetermined period of time, the input sensor 161-2 may detect the bio signal based on a change in an electric field caused by the part of the body so that the display module 140 may output user's desired information, for example.

The digitizer 161-3 may generate a data value corresponding to the coordinate information input by the pen. The digitizer 161-3 generates an amount of electromagnetic change by the input as a data value. The digitizer 161-3 may detect an input by the passive pen or transmit/receive data to/from the active pen.

At least one of the fingerprint sensor 161-1, the input sensor 161-2 and the digitizer 161-3 may be formed as a sensor layer on the display panel 141 through a continuous process. The fingerprint sensor 161-1, the input sensor 161-2 and the digitizer 161-3 may be disposed on the display panel 141. At least one of the fingerprint sensor 161-1, the input sensor 161-2 and the digitizer 161-3, e.g., the digitizer 161-3, may be disposed under the display panel 141.

At least two or more of the fingerprint sensor 161-1, the input sensor 161-2 and the digitizer 161-3 may be integrated into the sensing panel through the same process. When at least two or more of the fingerprint sensor 161-1, the input sensor 161-2 and the digitizer 161-3 are integrated into the sensing panel, the sensing panel may be disposed between the display panel 141 and a window disposed over an upper surface of the display panel 141. In an embodiment, the sensing panel may be disposed on the window. The inventive concept may not be limited to a position of the sensing panel.

At least one of the fingerprint sensor 161-1, the input sensor 161-2 and the digitizer 161-3 may be embedded in the display panel 141. In an embodiment, at least one of the fingerprint sensor 161-1, the input sensor 161-2 and the digitizer 161-3 is formed simultaneously with the display panel 141 through a process of forming elements included in the display panel 141 (e.g., light-emitting elements, transistors, etc.), for example.

In addition, the sensor module 161 may generate an electrical signal or a data value corresponding to an internal state or an external state of the electronic apparatus 101. In an embodiment, the sensor module 161 may further include a gesture sensor, a gyro sensor, a barometric pressure sensor, a magnetic sensor, an acceleration sensor, a grip sensor, a proximity sensor, a color sensor, an infrared (“IR”) sensor, a biosensor, a temperature sensor, a humidity sensor or an illuminance sensor, for example.

The antenna module 162 may include one or more antennas for transmitting a signal or power to outside or receiving a signal or power from outside. In an embodiment, the communication module 173 may transmit a signal to an external electronic apparatus or receive a signal from an external electronic apparatus through an antenna suitable for a communication method. An antenna pattern of the antenna module 162 may be integrated with an element of the display module 140 (e.g., the display panel 141) or the input sensor 161-2.

The sound output module 163 is a device for outputting sound signals to the outside of the electronic apparatus 101. In an embodiment, the sound output module 163 may include a speaker used for general purposes such as playing multimedia or recording and a receiver used exclusively for receiving a call, for example. In an embodiment, the receiver may be formed integrally with or separately from the speaker. A sound output pattern of the sound output module 163 may be integrated with the display module 140.

The camera module 171 may capture still images and moving images. In an embodiment, the camera module 171 may include one or more lenses, an image sensor or an ISP. The camera module 171 may further include an IR camera capable of determining a presence or an absence of a user, the user's location and the user's gaze.

The light module 172 may provide a light. The light module 172 may include a light-emitting diode or a xenon lamp. The light module 172 may operate in conjunction with the camera module 171 or operate independently.

The communication module 173 may support establishment of a wired or wireless communication channel between the electronic apparatus 101 and the external electronic apparatus 102 and communication through the established communication channel. The communication module 173 may include one or both of a wireless communication module such as a cellular communication module, a short-distance wireless communication module, or a global navigation communication module (“GNSS”) communication module and a wired communication module such as a local area network (“LAN”) communication module, or a power line communication module. The communication module 173 may communicate with the external electronic apparatus 102 through a short-range communication network such as Bluetooth™, WiFi direct or IR data association (“IrDA”) or a long-distance communication network such as a cellular network, the Internet, or a computer network (e.g., LAN or WAN). The various types of communication modules 173 described above may be implemented as a single chip or may be implemented as separate chips.

The input module 130, the sensor module 161 and the camera module 171 may be used to control the operation of the display module 140 in conjunction with the processor 110.

The processor 110 outputs commands or data to the display module 140, the sound output module 163, the camera module 171 or the light module 172 based on the input data received from the input module 130. In an embodiment, the processor 110 may generate image data corresponding to input data applied through a mouse or an active pen, and output the generated image data to the display module 140 or the processor 110 may generate command data corresponding to the input data and output the generated command data to the camera module 171 or the light module 172, for example. When input data is not received from the input module 130 for a predetermined period of time, the processor 110 converts an operation mode of the electronic apparatus 101 into a relatively low power mode or a sleep mode so that a power consumption of the electronic apparatus 101 may be reduced.

The processor 110 outputs commands or data to the display module 140, the sound output module 163, the camera module 171 or the light module 172 based on sensed data received from the sensor module 161. In an embodiment, the processor 110 may compare authentication data applied by the fingerprint sensor 161-1 with authentication data stored in the memory 120, and then execute an application according to the comparison result, for example. The processor 110 may execute commands or output corresponding image data to the display module 140 based on the sensed data sensed by the input sensor 161-2 or the digitizer 161-3. When the sensor module 161 includes a temperature sensor, the processor 110 may receive temperature data for the temperature measured from the sensor module 161 and may further perform luminance correction on the image data based on the temperature data.

The processor 110 may receive determined data about the presence or the absence of the user, the user's location and the user's gaze from the camera module 171. The processor 110 may further perform luminance correction on the image data based on the determined data. In an embodiment, the processor 110, which determines the presence or the absence of the user through an input from the camera module 171, may display image data having the luminance corrected by the data converting circuit 112-2 or the gamma correction circuit 112-3 to the display module 140, for example.

Some of the above elements may be connected to each other through a communication method between peripheral devices such as a bus, a general purpose input/output (“GPIO”), a serial peripheral interface (“SPI”), a mobile industry processor interface (“MIPI”), or an ultra path interconnect (“UPI”) link to exchange signals (e.g., commands or data) with each other. The processor 110 may communicate with the display module 140 through an agreed interface. In an embodiment, the processor 110 may communicate with the display module 140 through any one of the above communication methods. Embodiments of the disclosure may not be limited to the above communication methods, for example.

The electronic apparatus 101 according to various embodiments disclosed in the disclosure may be various types of apparatuses. In an embodiment, the electronic apparatus 101 may include at least one of a portable communication apparatus (e.g., a smart phone), a computer apparatus, a portable multimedia apparatus, a portable medical apparatus, a camera, a wearable device and a home appliance, for example. The electronic apparatus 101 in the embodiment of the disclosure may not be limited to the aforementioned apparatuses.

In an embodiment, the display panel 100 of FIG. 1 may correspond to the display panel 141 of FIG. 14, for example. In an embodiment, the driving controller 200 of FIG. 1 may correspond to the controller of the auxiliary processor 112 of FIG. 14. In an embodiment, the gate driver 300 of FIG. 1 may correspond to the scan driver 142 of FIG. 14, for example. In an embodiment, the data driver 500 of FIG. 1 may correspond to the data driver 143 of FIG. 14, for example.

By the embodiments of the gate driver and the display apparatus, the power consumption of the display apparatus may be reduced and the reliability of the gate driver may be enhanced.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A gate driver comprising:
a pull-up circuit which outputs a first clock signal as a gate output signal in response to a voltage of a first control node;
a pull-down circuit which pulls down the gate output signal to a power voltage in response to a voltage of a second control node;
a first control circuit which applies the first clock signal to the first control node in response to the voltage of the second control node;
a second control circuit which controls a voltage of the first control node in response to a voltage of a third control node and a second clock signal; and
a third control circuit which applies a masking enable signal to the third control node in response to the first clock signal.

2. The gate driver of claim 1, wherein the pull-up circuit comprises a ninth transistor including a control electrode connected to the first control node, a first electrode which receives the first clock signal and a second electrode connected to a gate output terminal.

3. The gate driver of claim 1, wherein the pull-down circuit comprises a tenth transistor including a control electrode connected to the second control node, a first electrode connected to a gate output terminal and a second electrode which receives the power voltage.

4. The gate driver of claim 1, wherein the first control circuit comprises an eleventh transistor including a control electrode connected to the second control node, a first electrode which receives the first clock signal and a second electrode connected to the first control node.

5. The gate driver of claim 1, wherein the second control circuit comprises:
a sixth transistor including a control electrode connected to the third control node, a first electrode connected to a first node and a second electrode which receives the second clock signal; and
a seventh transistor including a control electrode which receives the second clock signal, a first electrode connected to the first node and a second electrode connected to the first control node.

6. The gate driver of claim 5, wherein the second control circuit further comprises a second capacitor including a first electrode connected to the third control node and a second electrode connected to the first node.

7. The gate driver of claim 1, wherein the third control circuit comprises a third transistor including a control electrode which receives the first clock signal, a first electrode which receives the masking enable signal and a second electrode connected to a second node.

8. The gate driver of claim 7, wherein the gate driver further comprises a fourth transistor including a control electrode which receives the power voltage, a first electrode connected to the second node and a second electrode connected to the third control node.

9. The gate driver of claim 1, wherein the gate driver further comprises a fourth control circuit which controls the voltage of the third control node using the first clock signal in response to the voltage of the second control node.

10. The gate driver of claim 9, wherein the gate driver further comprises a short preventing circuit which prevents a short between the first clock signal and the voltage of the third control node.

11. The gate driver of claim 10, wherein the fourth control circuit comprises a fifth transistor including a control electrode connected to the second control node, a first electrode which receives the first clock signal and a second electrode connected to a third node, and
wherein the short preventing circuit comprises a twelfth transistor including a control electrode which receives the masking enable signal, a first electrode connected to the third node and a second electrode connected to a second node.

12. The gate driver of claim 1, wherein the gate driver further comprises a fifth control circuit which controls the voltage of the second control node using the second clock signal in response to the second control node.

13. The gate driver of claim 12, wherein the fifth control circuit comprises:
a second transistor including a control electrode connected to the second control node, a first electrode connected to a fourth node and a second electrode which receives the second clock signal; and
a third capacitor including a first electrode connected to the second control node and a second electrode connected to the fourth node.

14. The gate driver of claim 1, wherein the gate driver further comprises an input circuit which applies an input signal to the second control node in response to the first clock signal.

15. The gate driver of claim 14, wherein the input circuit comprises:
a first transistor including a control electrode which receives the first clock signal, a first electrode which receives the input signal and a second electrode connected to a fifth node; and
an eighth transistor including a control electrode which receives the power voltage, a first electrode connected to the fifth node and a second electrode connected to the second control node.

16. The gate driver of claim 1, wherein the gate driver further comprises a first capacitor including a first electrode which receives the first clock signal and a second electrode connected to the first control node.

17. The gate driver of claim 1, wherein in a state in which the masking enable signal has an inactive level, a gate output terminal outputs the gate output signal, and
wherein in a state in which the masking enable signal has an active pulse, the gate output terminal does not output the gate output signal.

18. A gate driver comprising:
a first transistor including a control electrode which receives a first clock signal, a first electrode which receives an input signal and a second electrode connected to a fifth node;
a second transistor including a control electrode connected to a second control node, a first electrode connected to a fourth node and a second electrode connected to the second control node;
a third transistor including a control electrode which receives the first clock signal, a first electrode which receives a masking enable signal and a second electrode connected to a second node;
a fourth transistor including a control electrode which receives a power voltage, a first electrode connected to the second node and a second electrode connected to a third control node;
a fifth transistor including a control electrode connected to the second control node, a first electrode which receives the first clock signal and a second electrode connected to a third node;
a sixth transistor including a control electrode connected to the third control node, a first electrode connected to a first node and a second electrode which receives a second clock signal;
a seventh transistor including a control electrode which receives the second clock signal, a first electrode connected to the first node and a second electrode connected to a first control node;
an eighth transistor including a control electrode which receives the power voltage, a first electrode connected to the fifth node and a second electrode connected to the second control node;
a ninth transistor including a control electrode connected to the first control node, a first electrode which receives the first clock signal and a second electrode connected to a gate output terminal;
a tenth transistor including a control electrode connected to the second control node, a first electrode connected to the gate output terminal and a second electrode which receives the power voltage;
an eleventh transistor including a control electrode connected to the second control node, a first electrode which receives the first clock signal and a second electrode connected to the first control node; and
a twelfth transistor including a control electrode which receives the masking enable signal, a first electrode connected to the third node and a second electrode connected to the second node.

19. The gate driver of claim 18, further comprising:
a first capacitor including a first electrode which receives the first clock signal and a second electrode connected to the first control node;
a second capacitor including a first electrode connected to the third control node and a second electrode connected to the first node; and
a third capacitor including a first electrode connected to the second control node and a second electrode connected to the fourth node.

20. The gate driver of claim 18, wherein in a state in which the masking enable signal has an inactive level, the gate output terminal outputs a gate output signal, and
wherein in a state in which the masking enable signal has an active pulse, the gate output terminal does not output the gate output signal.

21. A display apparatus comprising:
a display panel including a pixel;
a gate driver which outputs a gate output signal to the pixel, the gate driver comprising:
a pull-up circuit which outputs a first clock signal as the gate output signal in response to a voltage of a first control node;
a pull-down circuit which pulls down the gate output signal to a power voltage in response to a voltage of a second control node;
a first control circuit which applies the first clock signal to the first control node in response to the voltage of the second control node;
a second control circuit which controls a voltage of the first control node in response to a voltage of a third control node and a second clock signal; and
a third control circuit which applies a masking enable signal to the third control node in response to the first clock signal; and
a data driver which outputs a data voltage to the pixel.

22. The display apparatus of claim 21, wherein the gate driver further comprises:
a fourth control circuit which controls the voltage of the third control node using the first clock signal in response to the voltage of the second control node; and
a short preventing circuit which prevents a short between the first clock signal and the voltage of the third control node,
wherein the fourth control circuit comprises a fifth transistor including a control electrode connected to the second control node, a first electrode which receives the first clock signal and a second electrode connected to a third node, and
wherein the short preventing circuit comprises a twelfth transistor including a control electrode which receives the masking enable signal, a first electrode connected to the third node and a second electrode connected to a second node.

23. The display apparatus of claim 21, wherein in a state in which the masking enable signal has an inactive level, a gate output terminal outputs the gate output signal, and
wherein in a state in which the masking enable signal has an active pulse, the gate output terminal does not output the gate output signal.
